(19) United States
(12) Patent Application Publication
(10) Pub. No.: US 2014/0170395 A1
(43) Pub. Date: Jun. 19, 2014

(54) DURABLE METALLIC PRINTING

(71) Applicant: HEWLETT-PACKARD DEVELOPMENT COMPANY, LP, Houston, TX (US)

(72) Inventors: Vladek Kasperchik, Corvallis, OR (US); Phillip C. Cagle, San Diego, CA (US); David Michael Ingle, San Diego, CA (US)

(73) Assignee: Hewlett-Packard Development company, LP, Houston, TX (US)

(21) Appl. No.: 13/720,693

(22) Filed: Dec. 19, 2012

(51) Int. Cl. C09D 11/10; B32B 33/00

(52) U.S. Cl. CPC C09D 11/107; B32B 33/00
USPC 428/204; 524/265; 347/100

(57) ABSTRACT

The present disclosure is drawn to ink sets, printed articles, and related methods. An ink set can comprise a metallic ink and a latex-based overcoat ink. The metallic ink can include a first liquid vehicle and metal particles having an average particle size from 3 nm to 180 nm. The latex-based overcoat ink can include a second liquid vehicle and latex particles having an average particle size from 10 nm to 500 nm and a glass transition temperature from −20° C. to 200° C.

### BACKGROUND

Inkjet technology has expanded its application to high-speed, commercial and industrial printing, in addition to home and office usage, because of its ability to produce economical, high quality, multi-colored prints. This technology is a non-impact printing method in which an electronic signal controls and directs droplets or a stream of ink that can be deposited on a wide variety of substrates. More specifically, current inkjet printing technology involves forcing the ink drops through small nozzles by thermal ejection, piezoelectric pressure, or oscillation, onto the surface of a media.

As expanded colors and appearances are sought for home or office decorative printing, as well as for commercial package printing, developments have been made to provide inkjet prints and printed articles with specific features related to specialty inks. However, printed articles with such specific features are noticeably limited among current available options. Accordingly, investigations continue into developing media, ink, and/or printed articles that exhibit specific properties other than mere coloration.

### BRIEF DESCRIPTION OF THE DRAWING

The drawings illustrate various embodiments of the present ink sets, article, and methods, and are thus, part of the specification.

FIGS. 1A and 1B are schematic cross-sectional views of a printed article and its preparation in accordance with examples of the present disclosure;

FIGS. 2A and 2B are SEM photos of a latex-based overcoat layer, both before (2A) and after (2B) heat fusion, in accordance with examples of the present disclosure;

FIGS. 3A and 3B are TEM cross-sectional views of the latex-based overcoat layers of FIGS. 2A and 2B, but which also shows the metallic ink layer and the porous media substrate, both before (3A) and after (3B) heat fusion, in accordance with examples of the present disclosure;

FIG. 4 is a graph depicting the impact of time between application of a metallic ink layer and a latex-based overcoat layer in accordance with examples of the present disclosure;

FIGS. 5A and 5B are SEM photos of two examples where the time gap between application of the metallic ink layer and the latex-based overcoat layer was very short (10 ms) compared to a longer time gap (2 s) in accordance with examples of the present disclosure; and

FIG. 6 is a graph depicting a comparison of the reflectivity of fused prints as a function of latex-based overcoat in flux.

### DETAILED DESCRIPTION

The present disclosure is drawn to ink sets for durable metallic printing, a printed durable article with metallic appearance, and a method of forming a printed durable article with metallic appearance. In accordance with this, the ink set can comprise a metallic ink and a latex-based overcoat ink. The metallic ink includes a first liquid vehicle and metallic particles (such as elemental metal particles or metal oxide particles, e.g., iron oxide) having an average particle size from 3 nm to 180 nm. In one example, the metallic ink, when printed on a media substrate, particularly a porous media substrate having an average pore size that is smaller than the average particle size of the metallic particles, can provide a metallic luster to a resultant image printed therefrom. In one specific example, the metallic ink does not contain true metal (elemental) particles, but rather can include metal oxide particles that produce a layer with metallic appearance or reflectivity that simulates a metal layer on the print surface. Alternatively, true elemental metallic particles can be used instead of or in addition to the metal oxide particles. A latex-based overcoat ink is also included in the ink set and comprises a second liquid vehicle and latex particles having an average particle size from 10 nm to 500 nm and a glass transition temperature from −20° C. to 200° C. The metallic ink and the latex-based overcoat ink can include, independently, water, surfactant, organic co-solvent, binder, etc.

In another example, a durable printed article with metallic appearance can comprise a porous media substrate that includes a supporting base and a porous coating layer. The porous coating layer can provide the printing surface for receiving the inks. To the printing surface is applied a metallic ink layer having a metallic luster and comprising metal particles having an average particle size from 3 nm to 180 nm. Again, the metal particles can be metal oxide particles or elemental metal particles. A latex-based overcoat layer is also applied directly on the metallic ink layer after at least partial drying of the metallic ink layer such that the latex-based overcoat layer remains as a discrete layer with respect to the metallic ink layer, and wherein the metallic ink layer exhibits at least a portion of its metallic luster when viewed through the latex-based overcoat layer. For example, the metallic ink layer may exhibit a reflective appearance through the latex-based overcoat layer with a specular reflectivity at least two times greater than an unprinted portion of the porous coating layer. In another example, the reflective properties of the printed article can be defined as having at least 100 gloss units, measured at a 20° incident angle using a micro-TRI-gloss glossmeter (made by BYK).

In another example, a method for forming a printed durable article with a metallic appearance can comprise printing a metallic ink on a porous media substrate to form a metallic ink layer with a metallic luster, the metallic ink including metal particles having an average particle size from 3 nm to 180 nm. A subsequent step can comprise printing a latex-based overcoat ink directly on the metallic ink layer after the metallic ink layer has at least partially dried to form a discrete latex-based overcoat layer. The latex-based overcoat ink can include latex particles having an average size from 10 nm to 500 nm and a glass transition temperature from −20 C to 200° C. In one example, the glass transition temperature of the latex particles can be from 30° C. to 140° C. In certain specific examples, the method can further comprise the step of heat fusing the latex-based overcoat layer to the metallic ink layer at a temperature above the minimum film forming temperature (MFFT) (which can be lower than the glass transition temperature of the latex particles in some examples as a result of other factors such as the presence of a coalescing cosolvent).

By “at least partially dried” or “at least partially dry,” what is meant is that the metallic ink layer has enough time to dry so that it does not substantially mix with the subsequently applied latex-based overcoat layer. This may occur in a very short period of time, e.g., less than 0.1 second, less than 0.5 seconds, less than 1 second, less than 2 seconds, less than 5 seconds, etc. This is dependent on several factors, such as the porous media substrate properties, the ink vehicle properties, the temperature or conditions when printing, etc. By allowing the metallic ink layer to at least partially dry, the formation of two discrete or separate layers of ink (the metallic ink layer and the latex-based overcoat layer) can lead to improved results compared to more contemporaneous printing of the two layers. It is noted that “discrete” or “separate” refers to layers that are at least partially discrete, i.e. there can be some mixing at the interface, but there is at least some significant (e.g., more than 50%) portion of each layer that remains discretely separated from the adjacently printed layer. That being stated, when the two layers are printed close together in time so that a more significant amount of mixing occurs, as long as some of the metallic sheen remains, such examples are within the scope of the present disclosure.

Furthermore, the term “metal particles” described herein is defined to include two different types of particles, namely metal oxide particles, e.g., iron oxides, manganese oxides, etc., and elemental metal particles, e.g., elemental silver particles, elemental gold particles, elemental palladium, elemental platinum, elemental nickel (even with a thin and durable native oxide layer), etc. The term “metal particles” is not broad enough to encompass such materials as metal salts, metal complexes, or the like, whether soluble or insoluble in a given liquid. Furthermore, the term “metal particles” could likewise be referred to as transition or post transition metal particles. These particles are notably solid metallic masses of elemental metals or metal oxides that are dispersible (not soluble) in a liquid vehicle.

As another note, when discussing the latex-based overcoat ink or layer, the latexes can be colorless, clear, substantially colorless, or substantially clear, even though this is not always mentioned in the various examples herein. That being stated, it is understood that most latex particles are not always completely colorless or clear. However, when applied as described herein, the latex-based overcoat layer will typically appear to an ordinary observer to have essentially no noticeable color.

There are several reasons that the ink sets, printed articles, and methods of printing articles described herein are useful and represent an improvement in metallic printing. For example, metallic inks described herein that are based on metal oxide dispersions, particularly when treated with the polyether alkoxysilanes or other similar dispersing materials, show excellent jetting reliability and print quality, and can produce visually attractive decorative print effects that look metallic. Likewise, printing with elemental metal nanoparticles can also be attractive and impart a metallic sheen. However, both of these types of inks can lack some durability when printed. To describe one specific example, the surface of polyether-coated metal oxide particles can be very hydrophilic and a layer of the particles on a print surface can be easily re-dispersed in water and washed away. This results in a less than desirable waterfastness of the metal oxide prints. Another disadvantage of the metallic appearance of these prints is that they are easily susceptible to mechanical damage. Optically smooth reflective layers on the surface of these types of prints typically include tightly packed metal oxide nanoparticles that can be easily scratched during print handling. Thus, these otherwise attractive metallic inks can produce ink layers that sometimes are not as durable as would typically be desirable. By applying a substantially transparent and mechanically durable polymer overcoat film on top of the reflective metal oxide layer surface, at least some of, and often most of, the reflective properties can be retained and the durability significantly increased. In this example, a protective overcoat layer can be produced by jetting latex particles in a latex-based overcoat ink onto a print surface after deposition of a reflective metallic ink layer. In some examples, the latex particles can be fused into an essentially transparent or translucent durable coating, which protects the metallic ink layer from damage during handling and environmental exposure.

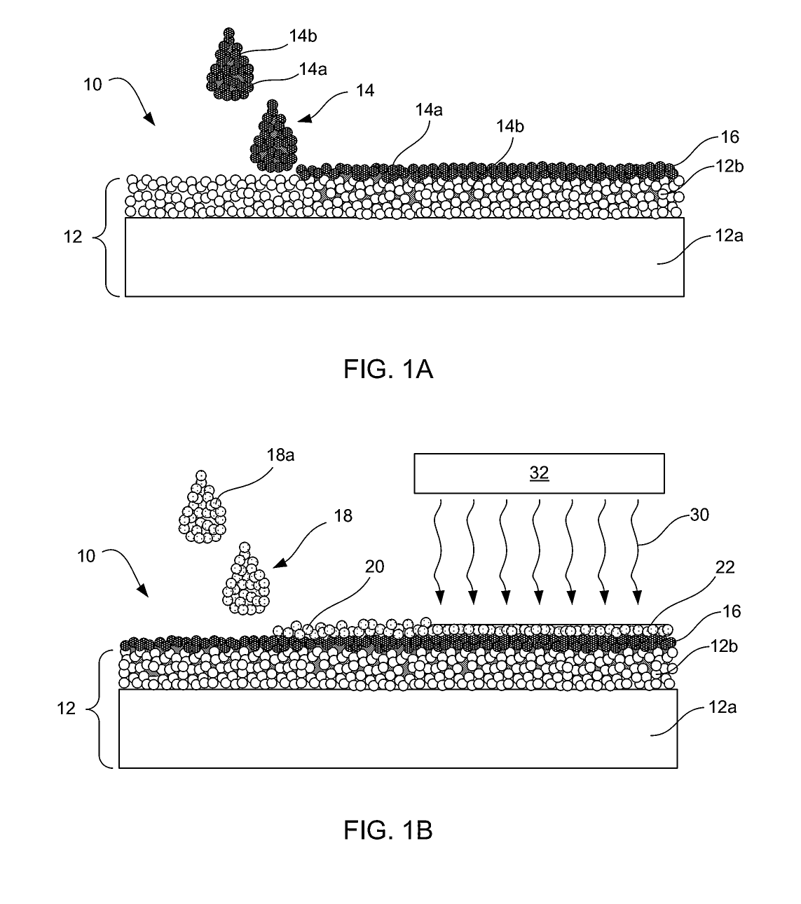

Turning now to specific structural and compositional components, as well as certain process steps of the present disclosure, and shown generally at 10 in FIGS. 1A and 1B, various details are provided by way of example regarding the porous media substrate 12, the metallic ink 14, and the latex-based overcoat ink 18. More specifically, the porous media substrate includes a supporting base 12a and a porous coating layer 12b. As mentioned, the inks of the present disclosure can be printed on a wide variety of substrates. However, one advantage of the present ink sets and methods is that porous media can be used and provide a high level of metallic sheen that approximates that provided by a true metallic layer, as will be described in greater detail hereinafter. The metallic ink includes both metallic particles 14a and liquid vehicle 14b. When printing the metallic ink on the porous media substrate, the liquid vehicle is drawn into pores of the porous coating layer, as shown, thus rapidly drying the resultant metallic ink layer 16. Once the metallic ink layer is at least partially dried, the latex-based overcoat ink, which includes latex particles 18a and a liquid vehicle (not shown), is then be applied to the metallic ink layer to form a latex-based overcoat layer 20, which can then be heat 30 fused using a heat generating source 32, to form an alternatively configured latex-based overcoat layer 22, i.e. heat fused. Each of these structural, compositional, and method examples are described in greater detail hereinafter.

Turning specifically to the media substrate, including the porous media substrates describe above, examples include various types of coated paper, but these inks work particularly well on porous coated media substrates with average pore sizes of less of less than about 180 nm, and more particularly ranging from about 2 nm to 150 nm. That being described, porous media substrates with larger pore sizes can also be used, but will not typically have as much sheen as porous media substrates with pore sizes smaller than the average size of the metal particles, e.g., metal oxide particles or elemental metal particles, in the ink. Furthermore, additional coatings can be applied to porous media substrates (either by ink jet ink or by more traditional analog coating methods) to reduce the size of the pores for a given porous media substrate to improve the sheen of the inks of the present disclosure. Thus, when referring to the “porous coating layer” of the porous media substrate, what is typically meant is the outermost porous coating layer that receives (and primarily stops) substantial penetration of the metal oxide particles into the pores of the porous coating layer. If there are multiple porous coating layers, the liquid vehicle portion of the metallic ink can be received in the pores of one or more of such layers, but in order to retain the metallic sheen of the image, the metal oxide particles typically remain substantially at the surface of the outermost coating layer. However, even when the desire is to generate a metallic sheen, some penetration of the metal oxide particles into the pores can still be acceptable, depending on the degree of metallic sheen desired.

In further detail regarding the porous media substrate, when coated with a printable porous coating, the porous media substrate can comprise both a supporting base and a porous coating layer. Suitable supporting base material that can be used includes paper, plastic, cardboard, etc., providing a bottom substrate layer suitable for a porous coating layer. Thus, applied to the supporting base is the porous coating layer, and together the supporting base and the porous coating layer form a recording material that can be well adapted for use with an inkjet printing device. As mentioned, the porous coating layer can be coated directly on the supporting base, or can be coated thereon with intermediate layers of similar or other compositions.

The supporting base and the porous coating layer may take the form of a sheet, a web, or a three-dimensional object of various shapes. Likewise, the supporting base can be of any type and size and can be any material that will be able to provide a mechanical support to the above-mentioned layers. In some examples, the supporting base can be a flexible film or a paper-based substrate, including both rigid and flexible substrates. The supporting base can also be selected from cellulosic or synthetic paper (coated or uncoated), cardboard, polymeric film (e.g. plastic sheet like PET, polycarbonate, polyethylene, polypropylene), fabric, cloth, and other textiles. The bottom substrate layer may also be a single material plastic film made from PET, polyimide, or another suitable polymer film with adequate mechanical properties. In some examples, the supporting base can include any substrate that is suitable for use in digital color imaging devices, such as electrophotographic and/or inkjet imaging devices, including, but in no way limiting to, resin coated papers (so-called photobase papers), regular papers, overhead projector plastics, coated papers, fabrics, art papers (e.g. water color paper), plastic film of any kind, and the like. In further detail, the supporting base can be paper (non-limitative examples of which include plain copy paper or papers having recycled fibers therein) or photopaper (non-limitative examples of which include polyethylene or polypropylene extruded on one or both sides of paper), and/or combinations thereof. In yet some other examples, the supporting base can be a photobase. Photobase is a coated photographic paper, which includes a paper base extruded on one or both sides with polymers, such as polyethylene and polypropylene. Photobase support can include a photobase material including a highly sized paper extruded with a layer of polyethylene on both sides. In this regard, the photobase support can be an opaque water-resistant material exhibiting qualities of silver halide paper. The photobase support can include a polyethylene layer having a thickness of 10 to 24 grams per square meter (gsm or g/m²). The photobase support can also be made of transparent or opaque photographic material.

As mentioned, coated on the supporting base is the porous coating layer described above. Typically, this layer is pre-coated on the supporting base by an analog process, i.e. non-digital process, using coating technology such as Meyer rod coating, curtain coating, knife coating, roller coating, spray coating, slot die coating, etc. With the porous coating layer present on the porous media substrate, the layer can have an average pore diameter that is either larger or smaller than the diameter (average size) of metal oxide particles used to print thereon. However, a greater metallic sheen can typically be realized when the average pore size of the porous media substrate is smaller than the average particle size of the metal oxide particles. As mentioned, if the pores are too large, metal particles will not stay up on the surface as well as when the pores are smaller, and the printed image will typically have a standard ink appearance and less of a metallic appearance. However, if the pores are too large, in one example, an additional coating can be applied to reduce the size of the pores further, making the new coating the “porous coating layer.”

Suitable inorganic particulate pigments that can be used to form porous coating layer, typically with a polymeric binder, include metal oxides and/or semi-metal oxides particles that may be independently selected from silica, alumina, boehmite, silicates (such as aluminum silicate, magnesium silicate, and the like), titania, zirconia, calcium carbonate, clays, or combinations thereof. In some examples, the inorganic pigments particles are modified or unmodified fumed silica. If silica is used, it can be selected from the group of commercially available fumed silica: Cab-O-Sil® LM-150, Cab-O-Sil® M-5, Cab-O-Sil® MS-55, Cab-O-Sil® MS-75D, Cab-O-Sil® H-5, Cab-O-Sil® HS-5, Cab-O-Sil® H-5, Aerosil® 150, Aerosil® 200, Aerosil® 300, Aerosil® 350, and/or Aerosil® 400. In some other examples, the inorganic particulate pigments are modified or unmodified alumina. The alumina coating can comprise pseudo-boehmite. Commercially available alumina particles can be used, including, but not limited to, Sasol Disperal® HP10, Disperal®HP14, boehmite, Cabot Cab-O-Sperse® PG003 and/or CabotSpectrAl® 81 fumed alumina.

Turning now to the inks and related coating layers of the present disclosure, there are essentially two types of inks and coating layers that are described herein, i.e. metallic inks and latex-based overcoat inks and their resultant coating layers. However, it is noted that other inks and/or layers can be included or applied using the ink sets of the present disclosure, such as standard inks with dye or pigment colorants, or multiple metallic inks and/or multiple latex-based overcoat inks. Thus, in describing the two types of inks of the present disclosure, it does not infer that only two inks are necessarily present or in use.

With reference to the metallic inks more specifically, in some examples, ink sets, printed articles, and methods described herein can be prepared to generate a metallic luster that provides high metallic reflectivity, and other high print quality characteristics, e.g., enhanced print edge definition, optical density, etc. For example, the printed articles prepared as described herein can have an optical reflectivity of a metal foil, or more commonly, at least a shiny metallic appearance. Thus, the printed article can exhibit a sparkling appearance from reflected light and can have the tendency to reflect at a specular angle when exposed to a directional light source. By “metallic appearance,” what is meant herein is that the printed article has an opaque or a semi-opaque appearance and reflects the light as a metal reflects light, i.e. shows strong directional reflectivity of incident light. Furthermore, by “metallic luster,” it is meant herein that the printed article has some characteristic of metals and can exhibit high gloss (at least 100 gloss units, but more typically, greater than 200 gloss units), or sheen, that is often referred to as looking “metallic.”

In certain examples, the ink sets and methods can be used to prepare a printed article that includes printed features having specular reflectivity that is superior or, at least equal, to 10%. This means that this printed layer is able to reflect light at a specular angle of at least 10% of the incident light intensity. In another example, the printed layer is able to reflect light at a specular angle of at least 25% of the incident light intensity. Without being bound by any theory, it is believed that the human perception of “metallic” of an object is related to ability of an observer to catch specular light reflection of directional light source coming off an object surface. The smooth surface begins to looks metallic if it is able to reflect at a specular angle more than, approximately, 10% of the incident light intensity (highly polished surface of true metals can reflect up to 85 to 95% of incident visible light). The higher is the intensity of the reflected light at specular angle (combined with low reflection off specular angle), the more metallic the appearance of the object surface. In one example, the latex-based overcoat layer and the metallic ink layer, in combination, form a printed feature with a combined thickness in the range of 40 nm to 10,000 nm. In this example, the printed feature can comprise metal oxide particles coverage in the range of 3 μg/cm² to 80 μg/cm².

The metallic ink composition used to form the metallic sheen or luster, as mentioned, forms an essentially uniform coating with strong sparkling and metallic reflective appearance, e.g., a metallic luster. As mentioned, elemental metal particles or metal oxide particles can be used. Though both are effective at generating metallic printed images, metal oxide particles are often more readily available and can be lower in cost. Additionally, with respect to printing, sometimes these types of particles even produce a superior appearance if formulated appropriately, such as is exemplified herein.

The metal oxide particles that can be used include titanium oxides (e.g., TiO₂), zinc oxides (e.g., ZnO), indium oxides (e.g., In₂O₃), manganese oxides (e.g., Mn₃O₄, MnO₂), iron oxides (e.g., Fe₃O₄), and mixtures thereof. Each of these categories of metal or metal oxides can include multiple compounds. For example, “iron oxide(s)” includes any chemical compounds composed of iron and oxygen including iron oxides, iron hydroxides, and oxide/hydroxides. Examples of iron oxides include iron (II) oxide (wüstite, FeO), iron (II,III) oxide (magnetite, Fe₃O₄) and iron (III) oxide (hematite, Fe₂O₃). Examples of iron hydroxides include iron (II) hydroxide (Fe(OH)₂) and iron (III) hydroxide (Fe(OH)₃) and oxihydroxide FeO(OH). Without being bound by any theory, it is believed that magnetite (Fe₃O₄) and hematite (Fe₂O₃) are oxidatively stable in aqueous environment; however, wüstite (FeO) is oxidatively unstable and can readily revert to Fe₂O₃ or Fe₃O₄. In one specific example, when the metal or metal oxide is provided by Fe₃O₄ iron oxide particles, the printed article exhibits a gold-like appearance. By “gold-like appearance,” what is meant is that the printed article has a visual appearance of gold-plated surface and has the color of metallic gold (Au). Thus, the printed article approximates the gloss, sheen, and color a gold object. The ink composition forms a uniform coating with strong metallic reflective appearance, which can have a metallic luster and gold-like appearance. Other metal oxides can be used to provide different metallic colors, or dyes can be added to any of these metallic oxides to modify the color of the metallic appearance. If an elemental metal nanoparticle is used to provide the metallic sheen, then suitable metal particles that can be selected include silver particles, gold particles, platinum group metals with oxidation resistance such as platinum and palladium, etc., transition metals that are surface protected by a thin and dense native oxide layer such as nickel, and the like.

As mentioned, the average particle size of the metal oxide particles or the elemental metal particles can be in the range of 3 nm to 180 nm. In some examples, the average particle size of metal particles can be in the range of 5 nm to 150 nm and, in some other examples, in the range can be from 10 nm to 100 nm. Particle sizes outside of this range can also be used, but for inkjet ink applications, these ranges are particularly practical. Furthermore, these metal or metal oxide particles can be present in the metallic ink at from 0.1 wt % to 15 wt % of the total weight of the ink composition. In some examples, the metal or metal oxide particles can be present in an amount ranging from 0.2 wt % to 12 wt %. In some other examples, the metal or metal oxide particles can be present in an amount ranging from 0.5 wt % to 6 wt % of the total weight of the ink composition.

The metallic particles can be dispersed with dispersants, though this is not always the case. Examples of suitable dispersants include, but are not limited to, water-soluble anionic species of low and high molecular weight such as phosphates and polyphosphates, phosphonates and polyphosphonates, phosphinates and polyphosphinates, carboxylates (such as citric acid or oleic acid), polycarboxylates (such as acrylates and methacrylates). Other examples include hydrolysable alkoxysilanes with alkoxy group attached to water-soluble (hydrophilic) moieties such as water-soluble polyether oligomer chains. In some examples, the dispersant used to disperse metallic particles, e.g., elemental metal or metal oxide, is a polyether alkoxysilane dispersant.

Examples of polyether alkoxysilane dispersants used to dispersed metal oxide particles can be represented by the following general Formula (I):

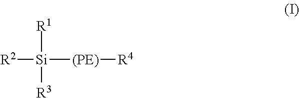

where R¹, R² and R³ are independently hydroxy groups or linear or branched alkoxy groups. In some examples, R¹, R² and R³ are linear alkoxy groups having from 1 to 5 carbon atoms. In some other examples, R¹, R² and R³ groups can independently or alternatively be —OCH₃ or —OC₂H₅. PE is a polyether oligomer chain segment of the structural formula [(CH₂)ₙ—CH(R)—O]ₘ, wherein n is an integer ranging from 0 to 3, and m is an integer superior or equal to 2 and wherein R is H or a chain alkyl group. R can also be a chain alkyl group having 1 to 3 carbon atoms, such as CH₃ or C₂H₅. In some examples, m is an integer ranging from 3 to 30 and, in some other examples, m is an integer ranging from 5 to 15. The polyether chain segment (PE) may include repeating units of polyethylene glycol (PEG) chain segment (—CH₂CH₂—O—), or polypropylene glycol (PPG) chain segment (—CH₂—CH(CH₃)—O—), or a mixture of both types. In some other examples, the polyether chain segment (PE) contains PEG units (—CH₂CH₂—O—). R⁴ can be independently hydrogen, or a linear or a branched alkyl group. In some examples, R⁴ is an alkyl group having from 1 to 5 carbon atoms.

Some other examples of polyether alkoxysilane dispersants used to dispersed metallic particles can be represented by the following general Formula (II):

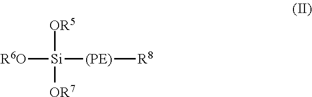

where R⁵, R⁶, and R⁷ are independently hydrogen, linear alkyl groups, or branched alkyl groups. In some examples, R⁵, R⁶, and R⁷ are independently linear alkyl groups having from 1 to 5 carbon atoms in chain length, and in other examples R⁵, R⁶, and R⁷ are independently —CH₃ or —C₂H₅. R⁸ can be independently hydrogen, or a linear or a branched alkyl group. In some examples, R⁸ is an alkyl group having from 1 to 5 carbon atoms.

Yet some other examples of polyether alkoxysilane dispersants used to dispersed metallic particles can be represented by the following general Formula (III):

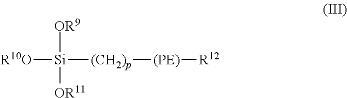

where R⁹, R¹⁰, and R¹¹ are the same as R⁵, R⁶, and R⁷, respectively, of Formula (II) above, (CH₂)ₚ is a linking group, where p is an integer ranging from 3 to 8, R¹² is the same as R⁸ of Formula (II) and R⁴ of Formula (I), and PE is the same as PE of Formulas (I) and (II).

Examples of suitable polyether alkoxysilanes that can be used include (CH₃O)₃Si—(CH₂CH₂O)ₘ—H, (CH₃CH₂O)₃Si—(CH₂CH₂O)ₘ—H, (CH₃O)₃Si—(CH₂CH₂O)ₘ—CH₃, (CH₃CH₂O)₃Si—(CH₂CH₂O)ₘ—CH₃, (CH₃O)₃Si—(CH₂CH₂O)ₘ—CH₂CH₃, (CH₃CH₂O)₃Si—(CH₂CH₂O)ₘ—CH₂CH₃, (CH₃O)₃Si—(CH₂CH(CH₃)O)ₘ—H, (CH₃CH₂O)₃Si—(CH₂CH(CH₃)O)ₘ—H, (CH₃O)₃Si—(CH₂CH(CH₃)O)ₘ—CH₃, and (CH₃CH₂O)₃Si—(CH₂CH(CH₃)O)ₘ—CH₃. Some other specific examples of polyether alkoxysilanes that may be used for the reactive dispersant molecules include HO(CH₂CH₂O)ₘ—(CH₂)₃—Si(OCH₃)₃, HO(CH₂CH₂O)ₘ—(CH₂)₃—Si(OCH₂CH₃)₃, CH₃O(CH₂CH₂O)ₘ—(CH₂)₃—Si(OCH₃)₃, CH₃O(CH₂CH₂O)ₘ—(CH₂)₃—Si(OCH₂CH₃)₃, C₂H₅O(CH₂CH₂O)ₘ—(CH₂)₃—Si(OCH₃)₃, C₂H₅O(CH₂CH₂O)ₘ—(CH₂)₃—Si(OCH₂CH₃)₃, HO(CH₂CH(CH₃)O)ₘ—(CH₂)₃—Si(OCH₃)₃, HO(CH₂CH(CH₃)O)ₘ—(CH₂)₃—Si(OCH₂CH₃)₃, CH₃O(CH₂CH(CH₃)O)ₘ—(CH₂)₃—Si(OCH₃)₃, and CH₃O(CH₂CH(CH₃)O)ₘ—(CH₂)₃—Si(OCH₂CH₃)₃. In any of the previous examples, the variable m is an integer equal to 2 or greater. In some examples, m is an integer ranging from 2 to 30, and in some other examples, m is an integer ranging from 5 to 15.

Commercial examples of the polyether alkoxysilane dispersants include, but are not limited to, Silquest®A-1230 manufactured by Momentive Performance Materials, and Dynasylan® 4144 manufactured by Evonik/Degussa.

The amount of dispersant used in the ink may vary from 1 wt % to 300 wt % based on the metal particle content. In some examples, the dispersant content range can be from 2 wt % to 150 wt % of the metallic particle content. In still other examples, the dispersant content range is from 5 wt % to 100 wt % of the metallic particle content. In still other examples, the ink composition is based on fine particles of metal oxide particles, such as Fe₃O₄, in an aqueous ink vehicle, and the dispersion of particles can be prepared via milling or dispersing the metal oxide powder in water in the presence of suitable dispersants.

As an example, an iron oxide (Fe₃O₄) pigment dispersion is used to describe principles of the present disclosure. However, other metal or metal oxide particle dispersions can also be prepared similarly. In this specific example, an Fe₃O₄ pigment dispersion may be prepared by milling commercially available inorganic oxide pigment having large particle size (in the micron range) in the presence of the dispersants described above until the desired particle size is achieved. The starting dispersion to be milled is an aqueous dispersion with solid content up to 40 wt % of the iron oxide particle. The milling equipment that can be used is a bead mill, which is a wet grinding machine capable of using very fine beads having diameters of less than 1.0 mm as the grinding medium, for example, Ultra-Apex Bead Mills from Kotobuki Industries Co. Ltd. The milling duration, rotor speed and temperature may be adjusted as known to those skilled in the art to achieve the results desired. The pH of the ink may be in the range of pH 3 to pH 11. In some examples, the pH of the ink can be from pH 5 to pH 9 and, in some other examples, from pH 5.5 to pH 9. The pH of the ink composition may be adjusted by addition of organic or inorganic acids or bases, i.e. pH adjusting agent, but this is not required. The ink composition, in one example, can have a viscosity within the range of 1 cps to 10 cps, or within the range of 1 cps to 7 cps, as measured at 25° C.

Turning now to the latex-based overcoat ink or layer prepared therefrom, the overcoating ink forms an essentially colorless or clear and mechanically durable protective coating on top of the reflective metal oxide layer. The latex particles of the latex-based overcoat ink are typically present at a concentration that is high enough for the latex particles to form a continuous layer with uniform coverage over the metallic ink layer. Typical latex particle content in the latex-based overcoat ink can thus be in the range from 0.5 wt % to 35 wt %, or from 0.5 wt % to 10 wt %, and more typically from 1 wt % to 5 wt %. At the higher end of the latex particle range, e.g., 10 wt % to 35 wt %, though such concentrations are usable, sometimes jetting reliability problems can occur. However, to the extent that these latexes are not printed using inkjet printheads, or can be jetted without clogging, such concentrations are also usable. Likewise, at the lower end of these ranges, jettability is not typically a problem, but uniform coverage can be more difficult, e.g., 0.5 wt % to 1 wt %.

The latex-based overcoat inks prepared in accordance with examples of the present disclosure can be produced by emulsion polymerization or co-polymerization of hydrophilic or acidic monomers and hydrophobic monomers, such as acrylic and styrene monomers in certain examples. A list of suitable monomers that can be used in various combinations include, but are not limited to, styrenes including substituted methyl styrenes, C1 to C8 alkyl methacrylates, C1 to C8 alkyl acrylates, polyol acrylates such as hydroxyethyl acrylate, polyol methacrylates, acrylate ester monomers, methacrylate ester monomers, acrylic acid, methacrylic acid, sulfoethyl methacrylate, sulfonates such as sodium 1-allyloxy-2 hydroxypropyl sulfonate, sulfate monomers, phosphate acid monomers, polymerizable surfactants, or the like. In some specific examples, if present, the acidic monomer content in the latex mix can be included at from 0.1 wt % and 15 wt %, and the styrene monomer, if present, can be included in the latex mix at from 0.1 wt % to 75 wt %, typically. Other latexes can likewise be used that function similarly, as would be appreciated by one skilled in the art after considering the present disclosure.

Suitable latex particle sizes can range from 10 nm to 500 nm, or from 50 nm to 300 nm. Glass transition temperatures of the latex particles can range from −20° C. to 200° C., though glass transition temperatures outside this range can also be used. In certain examples, the glass transition temperature of the latex particles can be from 30° C. to 140° C., or from 40° C. to 105° C. In examples where heat might or might not be used after application, the presence of latex particles with a glass transition temperature below 30° C. may be practical. If heat fusion is to be used, polymer particles with a glass transition temperature from 30° C. to 200° C. are typically used. It is also noted that any form of latex particles that are capable of forming a relatively smooth layer on the surface (with or without heat) can likewise be included, provided the latex-based overcoat layer allows the reflective properties of the metallic ink layer to be viewed there through while retaining at least a portion of metallic ink layer's metallic appearance. Examples of types of latex particles that are suitable for this may include homopolymer latex particles, copolymer latex particles, core-shell latex polymers (typically having a shell with a higher Tg than the core), etc. With core-shell latex polymers, in one example, the outer shell might have a glass transition temperature that can benefit from being melted or fused with heat, whereas the inner core may have a lower glass transition temperature that might not need heat were it not for being protected within the shell. That being stated, the term “core-shell” does not necessarily imply the actual particle morphology. Rather, as understood in the art, “core-shell” can also refer to two or more discrete polymer compositions created within the same particle by separately introducing and reacting sequential (and sometimes overlapping in time) monomer compositions during the polymerization process. In this latter model, the softer polymer component may be considered as a discrete softening agent or plasticizer for the harder polymer component. In either case, it is noted that when referring to the glass transition temperature of core-shell latex particles, it is often the shell that is used to determine whether heat fusion will be useful. Thus, when using a single glass transition temperature to characterize core-shell latex particles, the glass transition temperature of the shell is applicable unless the context dictates otherwise.

After the deposition of latex ink onto a print surface, the polymer particles can be fused into continuous protective layer during or immediately after the latex-based overcoat layer has dried or is drying. The polymer film produced this way resides on metal oxide particle layer and preserves it from damage during handling and environmental exposure. If the latex polymer particle minimum film formation temperature (MFFT) is lower or equal to ambient temperature, then fusing of the particles into continuous layer may not be needed, as the latex can be applied and fused accordingly without a heat fusing step. However, if the MFFT is higher than ambient temperature, heat fusing may be desirable to generate a smooth, essentially clear film. It is noted that the MFFT can be different than the glass transition temperature in certain examples, as film formation temperature can be dependent on other factors beyond the Tg, such as the presence of coalescing solvents, etc. Thus, “heat fusing” is defined as using heat to form a film, even if the heat is below the glass transition temperature of the latex particles in the latex-based overcoat layer. That being stated, in many instances, heating above the glass transition temperature can also provide good results.

Whether or not a heat fusing step is used, film formation properties can be adjusted by the addition of coalescing solvents or additives which are included in the latex-based overcoat ink, thus modifying the MFFT in some instances. Examples of such coalescing solvents or other additives include 2-pyrrolidinone, glycol ethers, or the like. These solvents can assist with film formation, particle deformation, improved surface smoothness, and subsequent improved film gloss, clarity, and film integrity.

In either case, whether or not coalescing solvents or other materials are present in the latex-based overcoat layer, heat fusing (e.g., radiant heat, forced air, IR, etc.) can be used to generate a relatively or even highly smoothed layer. In one example, upon fusing, the latex-based overcoat can be converted from a hazy/milky appearance (immediately after printing) to a clear layer (after heat fusing), which can sometimes indicate a microscopic thickness of the latex layer has been reduced, and can also typically indicate that the layer has been smoothed. Often, the heat fused latex-based overcoat can have a thickness of less than 100 nm, though this is not always the case.

With respect to inkjet applications in particular, the time gap between jetting of the latex-based overcoat ink following the metallic ink can be relatively short (fractions of a second to a few seconds). However, it has been discovered that the time between applications of layers should typically be long enough to prevent substantial mixing of the inks on the printing surface. A minimum time gap between layers can vary based on several factors, including the ink formulation, the type of paper, the pore volume and pore size found in the porous media coating, the drying setup in the printer, etc. For example, a printer may be set up with a heated printzone that might lower the amount of time between the metal oxide ink layer application and the latex-based overcoat layer application. If the latex-based overcoat ink is applied to the print surface before metallic ink has drained a portion or even most of its liquid phase into media porosity, then latex particles may be incorporated into the metallic ink layer, reducing the metallic appearance or durability of the printed image. For example, the incorporation of larger low reflective latex particles into an iron oxide nanoparticle layer creates defects in the print reflective layer, and those defects may degrade the reflectivity of the iron oxide layer, and in some instances, destroy metallic appearance of the print. Some mixing might occur and the result is still a printed article with a metallic appearance, but in other cases, the metallic reflectivity or metallic luster can be lost if too much mixing occurs. In one example, heat-assisted drying of the metallic layer can help with minimizing intermixing with the latex-based overcoat layer.

In other examples related to timing of the application of the respective layers, particularly with inkjet ink applications, steps of inkjet printing the metallic ink and the latex-based overcoat ink can be carried out from separate inkjet printheads that are both carried by a movable printer carriage, often a common movable printer carriage. Thus, in one example, the steps of inkjet printing the metallic ink can be carried out on a first pass of the printer carriage, and the step of inkjet printing the latex-based overcoat ink can be carried out on a subsequent pass of the printer carriage (second pass, third pass, fourth pass, etc.). The term “first pass” in this context does not necessarily mean the very first pass, but rather an earlier pass relative to a later pass of the printer carriage. Other techniques of creating time between applications of the two ink layers can also be implemented as well, as would be appreciated by one skilled in the art after considering the present disclosure. For example, allowing time for the metallic ink layer to at least partially dry can be carried out by other mechanisms, such as by the spatial separation of jetting orifices on a carriage or using separate carriages. Timing circuitry can also be used to allow for time to accrue for printing the latex-based overcoat ink onto the metallic ink layer as well. By any of these techniques, mixing at an interface between the metallic ink layer and the latex-based overcoat layer can be minimized.

Whether describing the latex-based overcoat ink or the metallic ink, the particles (e.g. latex particles, or metal/metal oxide particles, respectively) are typically prepared for printing and carried by a liquid vehicle. Stated more generally, as used herein, “liquid vehicle” is defined to include any liquid composition that is used to carry latex particles (in the latex-based overcoat ink) or metal/metal oxide particles (in the metallic ink) to the substrate. A wide variety of liquid vehicle components may be used therein, including a mixture of a variety of different agents, including without limitation, surfactants, solvent and co-solvents, buffers, biocides, viscosity modifiers, and water. In some examples, the liquid vehicle is an inkjet liquid vehicle. Typical liquid vehicle formulations described herein can include water, and can further include co-solvents present in total at from 0.1 wt % to 50 wt %, depending on the jetting architecture, though amounts outside of this range can also be used. For example, the solvent can be used in an amount representing from 0.1 wt % to 30 wt % of the ink composition, or can be used in an amount representing from 8 wt % to 25 wt % of the ink composition. The water can make up the a large portion of the liquid vehicle, and in some examples, may be present in an amount representing from 20 wt % to 90 wt %, or may be present in an amount representing from 30 wt % to 80 wt % of the total composition. Further, non-ionic, cationic, and/or anionic surfactants can be present, ranging from 0.01 wt % to 10 wt %. In addition to the particles carried by the respective inks as described herein, the inks can include more traditional colorants, though in the latex-based overcoat ink, this will typically not be the case unless the reason for inclusion is to match the color of a media substrate, or to render an ink more invisible by masking a discoloration, for example. The balance of the formulation can be any other vehicle components known in the art, such as biocides, viscosity modifiers, materials for pH adjustment, sequestering agents, preservatives, and the like.

Examples of suitable classes of organic solvents include polar solvents, such as amides, esters, ketones, lactones, and ethers. In additional detail, co-solvents that can be used can include organic co-solvents including aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, N-methylpyrrolidone (NMP), dimethyl sulfoxide, sulfolane, glycol ethers, alkyldiols such as 1,2-hexanediol, ethoxylated glycerols such as LEG-1, etc.

In addition to water and the other liquid vehicle components, various types of agents may be present in the ink composition to provide certain properties to the ink compositions for specific applications. The various ink compositions may also include, for example, any number of buffering agents and/or biocides. Examples of suitable biocides include, but are not limited to, benzoate salts, sorbate salts, commercial products such as Nuosept® (ISP), Ucarcide® (Dow), Vancide® (RT Vanderbilt Co.) and Proxel® (Avecia), Kordek® MLX (Rohm and Haas), and other known biocides. Such biocides may be contained in amount representing less than 5 wt % of the ink composition. Surfactants can also be used and may include water-soluble surfactants, such as alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, fluorosurfactants, and mixtures thereof. In some examples, fluorosurfactants or ethoxylated surfactants can be used as surfactants. In some other examples, ethoxylated silicone based surfactants are used. If used, the surfactant can be present at from 0.001 wt % to 10 wt % and, in some examples, can be present at from 0.001 wt % to 0.1 wt % of the ink compositions.

The printed article, depending on the porous media substrate chosen for printing, can be useful for forming articles that have, for examples, decorative applications, such as greeting cards, scrapbooks, brochures, signboards, wall paper, business cards, certificates, packaging, and other similar applications.

It is to be understood that this disclosure is not limited to the particular process steps and materials disclosed herein because such process steps and materials may vary somewhat. It is also to be understood that the terminology used herein is used for the purpose of describing particular examples only. The terms are not intended to be limiting because the scope of the present disclosure is intended to be limited only by the appended claims and equivalents thereof.

It is be noted that, as used in this specification and the appended claims, the singular forms “a,” “an,” and “the” include plural referents unless the context clearly dictates otherwise.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “1 to 5” should be interpreted to include not only the explicitly recited values of 1 to 5, but also include individual values and sub-ranges within the indicated range. Thus, included in this numerical range are individual values such as 2, 3, and 4 and sub-ranges such as from 1-3, from 2-4, and from 3-5, etc. Additionally, a numerical range with a lower end of “0” can include a sub-range using “0.1” as the lower end point.

### EXAMPLES

The following examples illustrate some embodiments of the present ink sets, printed articles, and methods that are presently known. However, it is to be understood that the following is only exemplary or illustrative of the application of the principles of the present disclosure. Numerous modifications and alternative ink sets, printed articles, and methods may be devised by those skilled in the art without departing from the spirit and scope of the present compositions and methods. The appended claims are intended to cover such modifications and arrangements. Thus, while the present ink sets, printed articles, and methods have been described above with particularity, the following examples provide further detail in connection with what are presently deemed to be acceptable examples.

### Example 1

### Metallic Ink Compositions with Metal Oxide Particle Colorants

Dispersions of metal oxide particles were prepared by milling the metal oxide powder, e.g., Fe₃O₄ powder (available from “Inframat Advanced Materials”) (used in Tables 1-3) and MnO₂ manganese oxide powder (used in Table 4). Such dispersions are produced by milling metal oxide powder in a “Kotobuki” Ultra-Apex Bead Mill (UAM-015) with a dispersant. The milling dispersant used was Silquest®A-1230 (available from “Momentive Performance Materials”).

With respect to Tables 1 and 3, the resultant Fe₃O₄ dispersion contained 5.6 wt % of metal oxide Fe₃O₄; the average particle size of Fe₃O₄ was 30 nm (as measured by “Nanotrac” particle size analyzer); and the dispersant to metal oxide particle ratio was 0.5. With respect to Table 2, the resulting Fe₃O₄ dispersion contained 5.5 wt % of metal oxide Fe₃O₄; the average particle size of Fe₃O₄ was 32 nm (as measured by “Nanotrac” particle size analyzer); and the dispersant to metal oxide particle ratio was 0.5. With respect to Table 4, the resulting MnO₂ dispersion contained 5 wt % of metal oxide MnO₂; the average particle size of MnO₂ was 25 nm (as measured by “Nanotrac” particle size analyzer); and the dispersant to metal oxide particle ratio was 0.5. Each of the formulations set forth below in Tables 1-4 exhibited excellent inkjetting reliability.

TABLE 1
Gold Reflective Ink (Magnetite “Gold” Ink Formulation I)

| Ingredient | Wt % |
|---|---|
| Fe₃O₄ Dispersion (5.6 wt % metal oxide) | 36.2 |
| LEG-1 (from Liponic) | 5 |
| 2-Pyrrolidinone | 9 |
| Proxel ®GXL | 0.1 |
| Surfynol ®465 | 0.2 |
| Trizma ®Base | 0.2 |
| Water | Balance |

TABLE 2
Gold Reflective Ink (Magnetite “Gold” Ink Formulation II)

| Ingredient | Wt % |
|---|---|
| Fe₃O₄ Dispersion (5.5 wt % metal oxide) | 36.2 |
| LEG-1 (from Liponic) | 5 |
| 2-Pyrrolidinone | 9 |
| Proxel ®GXL | 0.1 |
| Surfynol ®465 | 0.2 |
| Joncryl 683 Resin (K Salt) | 0.1 |
| Water | Balance |

TABLE 3
Neutral Gray Reflective Ink (Magnetite “Silver” Ink Formulation)

| Ingredient | Wt % |
|---|---|
| Fe₃O₄ Dispersion (5.6 wt % metal oxide) | 36.2 |
| LEG-1 (from Liponic) | 5 |
| 2-Pyrrolidinone | 9 |
| Proxel ®GXL | 0.1 |
| Surfynol ®465 | 0.2 |
| Joncryl 683 resin (potassium salt) | 0.1 |
| AR-52 Magenta dye solution | 0.675 |
| (Abs.(1:10 K) at 565 nm = 1.353) | |
| ProJet Cyan C854 dye solution | 3.25 |
| (Abs.(1:10 K) at 619 nm = 0.487) | |
| ProJet Magenta 700 dye solution | 1.5 |
| (Abs.(1:5 K) at 503 nm = 0.554) | |
| Water | Balance |

TABLE 4
Metallic Reflective Ink (Manganese Ink Formulation)

| Ingredient | Wt % |
|---|---|
| MnO₂ Dispersion (5 wt % metal oxide) | 39.6 |
| LEG-1 (from Liponic) | 5 |
| 2-Pyrrolidinone | 9 |
| Proxel ®GXL | 0.1 |
| Surfynol ®465 | 0.2 |
| Trizma ®Base | 0.2 |
| Water | Balance |

### Example 2

### Silver Reflective Ink with Elemental Silver Nanoparticle Colorants

A metallic silver nanoparticle based ink formulation was prepared in accordance with Table 5, as follows:

TABLE 5
Silver Reflective Ink (True Silver Ink Formulation)

| Ingredient | Wt % |
|---|---|
| Metallic Silver Nanoparticles (Mv = 25-40 nm) | 2 |
| Tetraethylene Glycol | 9 |
| Tergitol ®15-S-7 | 1 |
| Surfynol ®465 | 0.5 |
| Water | Balance |

### Example 3

### Latex-Based Overcoat Ink

Multiple latex-based overcoat inks were prepared that are capable of forming clear protective coating. The total content of latex solids (particles) in each formulation tested was at 4 wt %, even though the relative concentrations for each latex formulation differed. Specifically, Table 6 sets forth the three latex-based overcoat inks prepared, as follows:

TABLE 6
Latex-based overcoat Inks

| | Wt % | | |
|---|---|---|---|
| Ingredient | Latex Ink 1 | Latex Ink 2 | Latex Ink 3 |
| 2P | 16 | 16 | 16 |
| 2-Methyl, 1,3-Propanediol | 9 | 9 | 9 |
| Crodafos N-3 Acid | 0.2 | 0.2 | 0.2 |
| Tergitol 15-S-7 | 0.8 | 0.8 | 0.8 |
| Trilon M | 0.04 | 0.04 | 0.04% |
| Latex 1 (solids = 42.1%) | 9.51 | | |
| Latex 2 (solids = 35%) | | 11.43 | |
| Latex 3 (solids = 40%) | | | 10 |
| Water | Balance | Balance | Balance |

The lattices used in Table 6 above for the latex-based overcoat inks were produced by emulsion polymerization of styrene and acrylate monomers. Specifically, Latex 1 had mean particle size (Mv) of 240 nm and a Tg˜102° C. (as measured by DSC); Latex 2 had mean particle size (Mv) of 90 nm and a Tg˜30° C.; and Latex 3 included a 50/50 core/shell latex particle with mean particle size (Mv) of 230 nm and a Tg of −17° C. (core) and 93° C. (shell). It is noted that in examples where the core has a Tg that is less than room temperature and a shell that is significantly greater than room temperature (as with Latex 3), heat fusing can be used to assist with forming a more uniform layer over the metallic ink layer in accordance with examples of the present disclosure.

### Example 4

### Heat Fusing Latex-Based Overcoat Layers

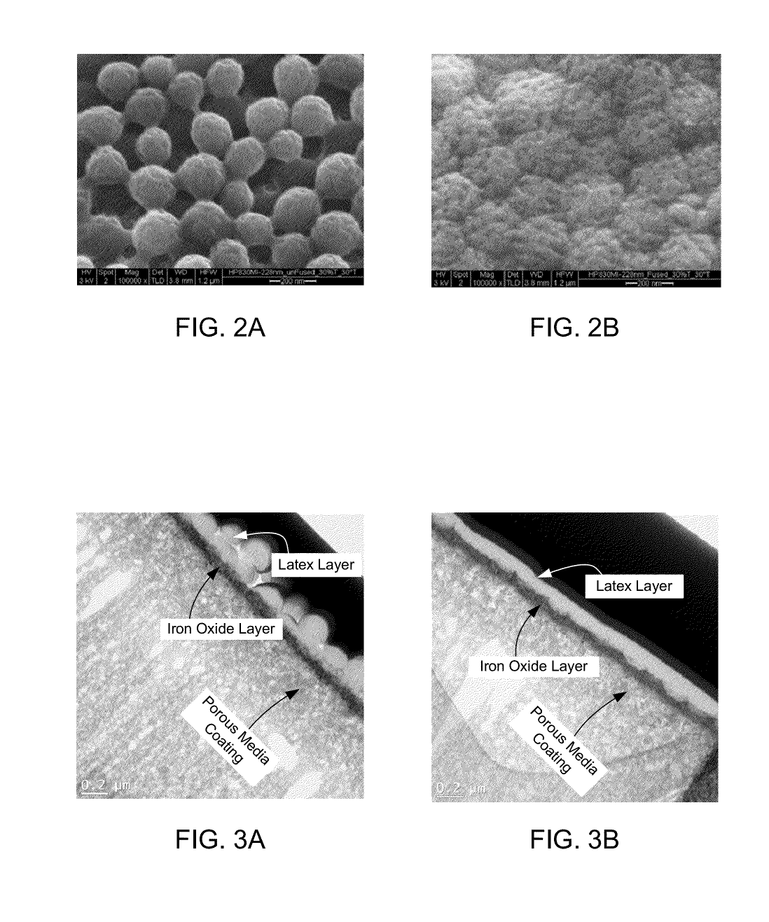

The metallic ink of Table 2 (Magnetite “Gold” Ink Formulation II) was jetted from an inkjet printer onto a porous media substrate (HP Advanced Photo Paper) to form a metallic ink layer with a gold appearance. The equipment used to inkjet each ink was an HP Black Ink Cartridge 940 and an HP Office Jet Pro 8000 printer. After the metallic ink layer had at least partially dried, Latex Ink 3 of Table 6 was inkjetted over the metallic ink layer. The latex-based overcoat layer produced is shown in FIG. 2A, which is an SEM photo of the layer after printing but before heat fusing. After heat fusing using a heat gun at a temperature just greater than about 100° C. until the latex-based overcoat layer turned from a milky appearance to transparent (up to about 30-40 seconds), the latex-based overcoat layer shown in FIG. 2B was formed. In further detail, FIGS. 3A and 3B show TEM cross-sectional photos of the various layers before and after fusing.

As can be seen, after heat fusing, a more uniformly fused latex-based overcoat layer is formed. It is noted, however, that in this example that the ink solvents that are also present in this latex formulation contribute to the fusion, as the solvent interacts with latex and coalesce the latex particles. Regarding the structure shown in FIG. 2A, because of the less uniform and rough surface of the unfused latex coating, more light is scattered and the metallic sheen of the metallic layer is not as pronounced as when the latex-based overcoat layer is heat fused. It is noted, however, that the step of heat fusion is used in this example because of the structural nature of the latex-based overcoat layer formed. More specifically, the latex-based overcoat layer including the core-shell latex particles and this particular solvent system is benefited by the heat fusion step, as shown. In other examples, heat fusion may not be needed or desirable, particularly when the latex can form a relatively uniform coating without heat fusion.

### Example 5

### Impact of Latex-Based Overcoat Layer on Metallic Ink Layer Reflectivity Over Time

A metallic iron oxide ink as described in Table 2 (Magnetite “Gold” Ink Formulation II) and Latex Ink 1 (standard latex; 240 nm; ˜102° C. Tg) of Table 6 were each filled in separate chambers of an HP Black Ink Cartridge 940 and printed from HP Office Jet Pro 8000 printer. The print media used was HP Advanced Photo Paper. The metallic ink was jetted on the media first followed by the latex-based overcoat ink. The time lapse between jetting the metallic ink and the latex-based overcoat ink was as follows: 1) 10 millisecond time lapse because both inks were jetted from adjacent slots of the printhead during the same printer carriage pass or sweep; and 2) 2 seconds because the inks were jetted during separate carriage passes or sweeps, i.e. metallic ink printed first and the latex-based overcoat ink printed on a second pass.

The metallic ink was jetted onto the media surface at constant ink flux density equal to 65 pL per 1/300^{th} pixel. This ink density of the magnetite reflective layer had a thickness from about 80 nm to 90 nm. The latex-based overcoat layer was applied onto the top of metallic ink with ink flux densities varying from 0 to 60 pL per 300^{th} pixel at 15 pL per 300^{th} increments. After the overcoating layer deposition, the print surface was exposed for 5 to 10 seconds of a jet of hot air (110-120° C.) to fuse individual latex particles into continuous protective coating, producing mechanically durable prints that were not marred after extended rubbing.

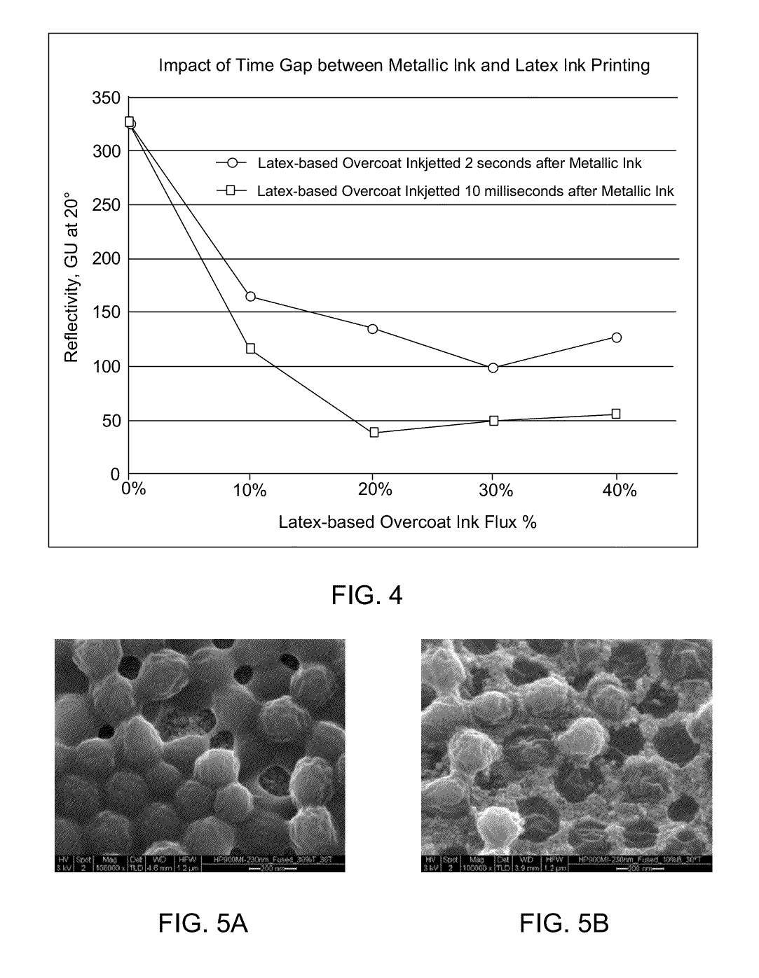

FIG. 4 provides a reflectivity comparison of the metallic ink at different overcoating ink fluxes at only 10 milliseconds (single pass; represented by square data points) and at 2 seconds (separate passes; represented by circle data points), as described above. As can be seen, by allowing the metallic ink layer to dry a little bit longer, reflectivity can be enhanced. That being stated, the “single pass” example still provides a metallic sheen and spectral reflectivity for many of the latex-based overcoat ink fluxes, but it is just not as strong as when a short amount of time is allow pass between ink application layers. This improvement by a slight delay in printing the second layer can be partially explained as shown by the SEM photos of FIGS. 5A and 5B. The impact of the jetting time gap on the metallic ink and latex-based overcoat layers with respect to intermixing is specifically shown, where FIG. 5A was prepared with a 2 second gap in time, and FIG. 5B was prepared with a 10 millisecond gap in time. It is noted that neither of these images show a heat fused layer at this stage. Heat fusing would occur thereafter, which was the case with respect to the data presented in FIG. 4. With respect to the image shown in FIG. 5A, the latex-based overcoat ink jetted onto the metallic ink after 2 seconds exhibited larger latex particles, forming a more separate and discrete layer on top of iron oxide nanoparticles. Alternatively, the latex-based overcoat ink jetted onto the metallic ink after only 10 milliseconds caused the larger latex particles to be incorporated into the metallic ink layer, degrading its reflectivity.

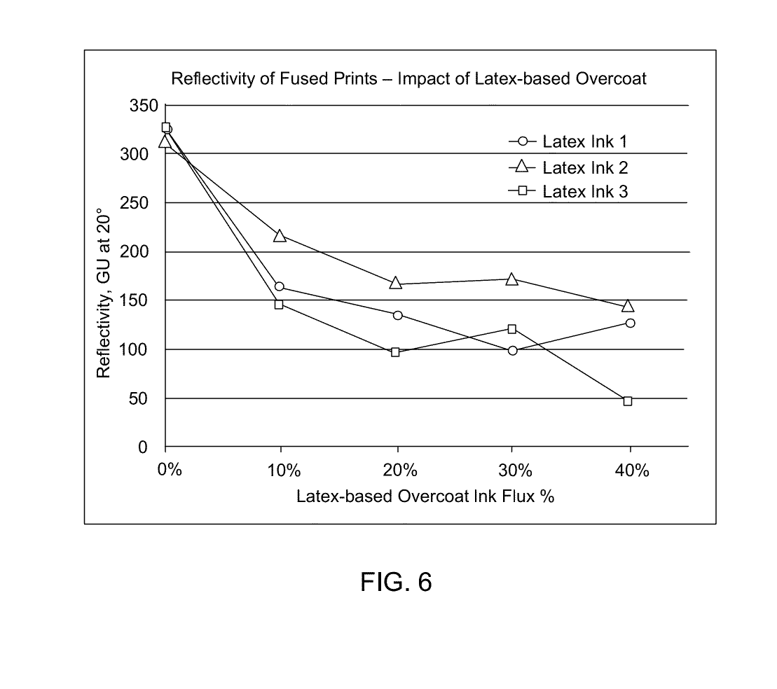

In further detail, it has been discovered that print reflectivity is usually reduced after the application of latex-based overcoat layer to some degree. Furthermore, the reflectivity drop gets more noticeable with increase in the latex-based overcoat ink flux and layer thickness. Nevertheless, the print still preserves its metallic appearance. Thus, a balance between coating thickness of the latex and durability can be struck to achieve both acceptable durability and retention of the metallic luster. In one example, a reflectivity of at least about 100 gloss units (measured at 20° incident angle) provides a good level of gloss to preserve the metallic appearance. In accordance with this, print reflectivity can be characterized by measuring its 20° gloss by “micro-TRI-gloss” glossmeter (made by “BYK”). The data presented on FIG. 6 indicates that the overcoat inks prepared based on latex particles with smaller particle sizes, e.g., Latex Ink 2 (˜90 nm) produced coated prints with lower reflectivity loss. Overcoat inks based on lager latex particles, e.g., Latex Inks 1 and 3 (˜230-240 nm) produced coated prints with larger reflectivity loss.

While the present technology has been described with reference to certain examples, those skilled in the art will appreciate that various modifications, changes, omissions, and substitutions can be made without departing from the spirit of the disclosure. It is intended, therefore, that the disclosure be limited only by the scope of the following claims.

1. An ink set for metallic printing, comprising:
a metallic ink comprising a first liquid vehicle and metal particles having an average particle size from 3 nm to 180 nm; and
a clear or colorless latex-based overcoat ink comprising a second liquid vehicle and latex particles having an average particle size from 10 nm to 500 nm and a glass transition temperature from −20° C. to 200° C.

2. The ink set of claim 1, wherein the metal particles are metal oxide particles selected from the group consisting of titanium oxides, zinc oxides, indium oxides, manganese oxides, iron oxides, and mixtures thereof.

3. The ink set of claim 1, wherein the metal particles are elemental metal particles selected from the group consisting of silver particles, gold particles, platinum particles, palladium particles, nickel particles, and mixtures thereof.

4. The ink set of claim 1, wherein the metal particles are present in the metallic ink at from 0.1 wt. % to 15 wt. % of the metallic ink, and wherein the latex particles are present in the latex-based overcoat ink at from 0.5 wt. % to 35 wt. % of the latex-based overcoat ink.

5. The ink set of claim 1, wherein the metal particles are dispersed in the metallic ink with a polyether alkoxysilane dispersant.

6. The ink set of claim 1, wherein the latex particles are an emulsion polymer of a styrene monomer and a monomer selected from the group consisting of C1 to C8 alkyl methacrylates, C1 to C8 alkyl acrylates, polyol acrylates, polyol methacrylates, acrylate ester monomers, methacrylate ester monomers, acrylic acid, methacrylic acid, sulfoethyl methacrylate, sulfonates, sulfate monomers, phosphate acid monomers, polymerizable surfactants, and combinations thereof.

7. The ink set of claim 1, wherein the latex particles range in average particle size from 50 nm to 300 nm, and wherein the glass transition temperature of latex particles is from 30° C. to 140° C.

8. A durable printed article with metallic appearance, comprising:
a porous media substrate comprising a supporting base and a porous coating layer having a printing surface;
a metallic ink layer applied to the printing surface, the metallic ink layer having a metallic luster and comprising metal particles having an average particle size from 3 nm to 180 nm; and
a latex-based overcoat layer applied directly on the metallic ink layer after at least partial drying of the metallic ink layer such that the latex-based overcoat layer remains as a discrete layer with respect to the metallic ink layer, wherein the metallic ink layer exhibits at least a portion of its metallic luster as viewed through the latex-based overcoat layer.

9. The printed article of claim 8, wherein the latex-based overcoat layer is heat fused after application to the metallic ink layer.

10. The printed article of claim 8, wherein the metallic luster of the metallic ink layer through the latex-based overcoat layer is measured to exhibit, either before or after heat fusion: i) at least 100 gloss units; or ii) a specular reflectivity at least two times greater than an unprinted portion of the porous coating layer.

11. The printed article of claim 8, wherein the porous coating layer has an average pore size from 2 nm to 150 nm, wherein the average particle size of the metal particles is larger than the average pore size the porous coating layer, and wherein the metallic ink layer and the latex-based overcoat layer, in combination, form a printed feature with a combined thickness in the range of 40 nm to 10,000 nm and a metal particles coverage in the range of 3 μg/cm² to 80 μg/cm².

12. The printed article of claim 8, wherein the porous coating layer of the porous media substrate comprises inorganic pigments and binder; wherein the metal particles of the metallic ink layer includes metal particles selected from the group of titanium oxides, zinc oxides, indium oxides, manganese oxides, iron oxides, elemental silver particles, elemental gold particles, platinum particles, palladium particles, nickel particles, and mixtures thereof; and wherein the latex particles are an emulsion polymer of a styrene monomer and a monomer selected from the group of C1 to C8 alkyl methacrylates, C1 to C8 alkyl acrylates, polyol acrylates, polyol methacrylates, acrylate ester monomers, methacrylate ester monomers, acrylic acid, methacrylic acid, sulfoethyl methacrylate, sulfonates, sulfate monomers, phosphate acid monomers, polymerizable surfactants, and combinations thereof.

13. A method for forming a printed durable article with a metallic appearance, comprising:
printing a metallic ink on a porous media substrate to form a metallic ink layer with a metallic luster, the metallic ink including metal particles having an average particle size from 3 nm to 180 nm; and
printing a latex-based overcoat ink directly on the metallic ink layer after the metallic ink layer has at least partially dried to form a discrete latex-based overcoat layer, the latex-based overcoat ink including latex particles having an average size from 10 nm to 500 nm and a glass transition temperature from −20 C to 200° C.

14. The method of claim 13, wherein the glass transition temperature of the latex particles is from 30° C. to 140° C., and the method further comprising the step of heat fusing the latex-based overcoat layer to the metallic ink layer at a temperature above a minimum film formation temperature (MFFT) of the latex-based overcoat ink.

15. The method of claim 13, wherein the steps of printing the metallic ink and the latex-based overcoat ink is by inkjet printing the metallic ink and the latex-based overcoat ink from respective inkjet printheads carried by a movable printer carriage, wherein the step of inkjet printing the metallic ink is on a first pass of the printer carriage, and the step of inkjet printing the latex-based overcoat ink is on a subsequent pass of the printer carriage.

16. The ink set of claim 1, wherein the metallic ink and the latex-based overcoat ink are formulated such that when the metallic ink is printed on a porous media substrate comprising a supporting base and a porous coating layer having a printing surface and then is overcoated with the latex-based overcoat ink, the metallic luster of the metallic ink layer through the latex-based overcoat layer is measured to exhibit, either before or after heat fusion: i) at least 100 gloss units; or ii) a specular reflectivity at least two times greater than an unprinted portion of the porous coating layer.
